(19) United States
(12) Patent Application Publication
(10) Pub. No.: US 2012/0257396 A1
(43) Pub. Date: Oct. 11, 2012

(54) GLASS BULB COVER AND A SOFT CORE ASSEMBLY CONNECTING THEREWITH

(76) Inventor: Ho-Hsin CHIU, Hsinchu City (TW)

(21) Appl. No.: 13/219,097

(22) Filed: Aug. 26, 2011

(30) Foreign Application Priority Data
Apr. 6, 2011 (CN) 201120105973.3

(51) Int. Cl. F21V 3/00

(52) U.S. Cl. 362/363

(57) ABSTRACT

A positioning device for a drill tool contains a base including a groove to insert and limit the drilling tool; a fixing assembly disposed on the base so that the base is fixed on a workpiece; a pad mounted on a bottom end of the base so that its bottom end abuts against the workpiece tightly and including a receiving chamber mounted therein to correspond to the groove of the base, thereby a cool fluid is fed into the receiving chamber, and the drilling tool inserted in the limiting range is driven to have the drilling process so that during the drilling process, the pad surrounds the drilling tool and the desired drilling position on the workpiece, the receiving chamber is full of cool fluid to cool the drilling tool quickly and to prevent the cool fluid and clips from splash, thus prolonging a service life of the drilling tool.

### BACKGROUND OF THE INVENTION

1. Field of the Invention

The present invention relates to a glass bulb cover and a soft core assembly connecting therewith to be used in a LED Christmas lamp.

2. Description of the Prior

A conventional glass bulb cover disclosed in CN Patent No. 200820202554.X includes a hollow body made of glass material, a soft connecting member made of plastic material and integrally formed with a cable having a terminal, and a plastic retaining sleeve fitted with a distal end of the body, wherein the retaining sleeve includes at least one boss fixed on an outer surface thereof, the soft connecting member includes an axial guiding slot formed on an inner surface thereof, the axial guiding slot has a width to match with the boss; and the soft connecting member also includes a stopping groove to be perpendicular to and communicating with the axial guiding slot. However, the boss can not be integrally formed on the body, accordingly the plastic retaining sleeve with a projection has to be used to retain with the boss of the body. Furthermore, the guising slot is disposed on the inner surface of the soft connecting member, a space is arranged in the soft connecting member to receive a soft core assembly and a LED element, so a size of the soft connecting member has to be increased, causing a high production cost.

The present invention has arisen to mitigate and/or obviate the afore-described disadvantages.

### SUMMARY OF THE INVENTION

The primary object of the present invention is to provide a glass bulb cover that is removed easily and is connected with the soft core assembly at less time and cost.

A glass bulb cover provided by the present invention contains:

a hollow body made of glass material and including a hollow column extending downward from the body, the hollow column includes at least one boss arranged on an outer surface thereof to connect with a soft core assembly;

wherein the at least one boss is formed in a trapezium shape;

wherein the at least one boss is formed in a circular post shape;

wherein the at least one boss is formed in a hemisphere shape;

wherein the at least one boss is fixed and equiangularly spaced on the outer surface of the hollow column of the body;

wherein the soft core assembly includes a hollow seat to receive a LED element disposed on a top end thereof, characterized in that the soft core assembly includes a circular loop concentric with the seat, the loop has an inner diameter to match with an outer diameter of the hollow column of the body and at least one axial guiding slot formed on an inner wall thereof, the loop also has a stopping groove perpendicular to and communicating with the at least one guiding slot, and a number of the at least one axial guiding slot is equal to that of the at least one boss;

wherein the stopping groove has a width becomes decreasingly;

wherein the circular loop further includes a positioning tab secured on an outer surface thereof.

### BRIEF DESCRIPTION OF THE DRAWINGS

FIG. 1 is a perspective view showing the assembly of a glass bulb cover according to a first embodiment of the present invention;

FIG. 2 is a perspective view showing the assembly of a glass bulb cover according to a second embodiment of the present invention;

FIG. 3 is a perspective view showing the assembly of a soft core assembly according to the first embodiment of the present invention;

FIG. 4 is a cross sectional view showing the assembly of the glass bulb cover according to the first embodiment of the present invention;

FIG. 5 is a cross sectional view showing the exploded components of the glass bulb cover and a soft core assembly according to the first embodiment of the present invention;

FIG. 6 is a cross sectional view showing the assembly of the glass bulb cover and the soft core assembly according to the first embodiment of the present invention;

FIG. 7 is a plan view showing the assembly of another glass bulb cover according to the first embodiment of the present invention;

FIG. 8 is a plan view showing the assembly of another glass bulb cover according to the first embodiment of the present invention.

### DETAILED DESCRIPTION OF THE PREFERRED EMBODIMENTS

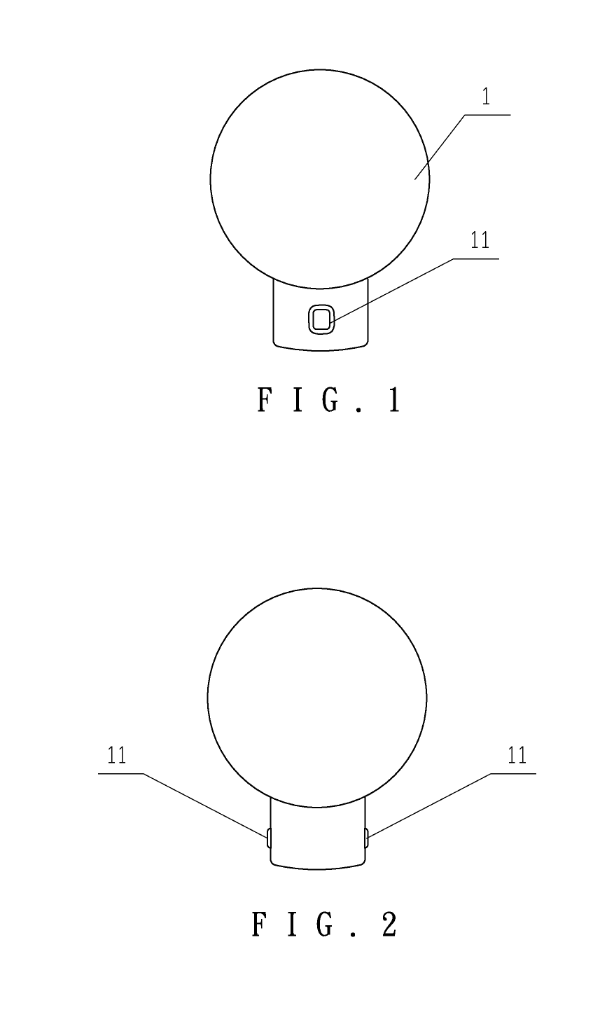

Referring to FIGS. 1 and 2, a glass bulb cover and a soft core assembly connecting therewith according the present invention comprises a hollow body 1 made of glass material and including a hollow column extending downward from the body 1, the hollow column includes at least one boss 11 arranged on an outer surface thereof.

As shown in FIG. 1, there is one boss 11 provided in a first embodiment and is formed in any one of a trapezium shape, a circular post shape, and a hemisphere shape. As illustrated in FIG. 2, there are two bosses 11 provided in a second embodiment. In addition, three bosses 11 are capable of being fixed and equiangularly spaced on the outer surface of the hollow column of the body 1.

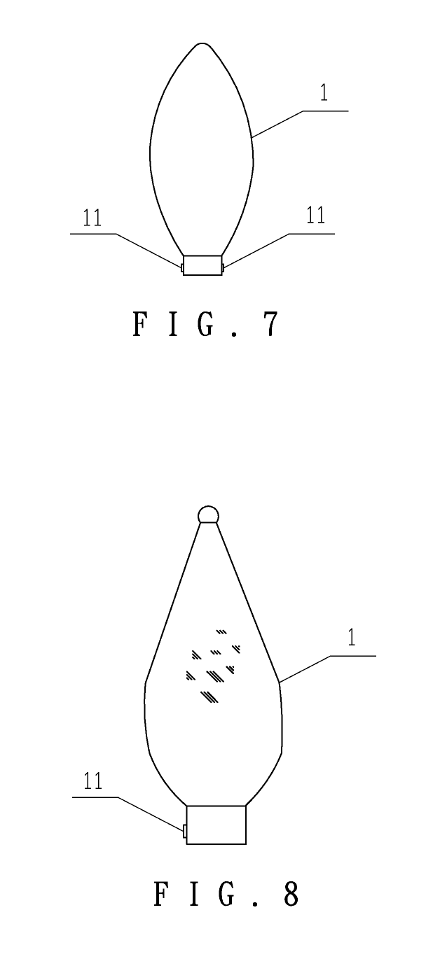

In the first embodiment, as shown in FIG. 1, the body 1 is formed in a sphere shape; the body 1 is formed in a candlelight shape as illustrated in FIG. 7; the body 1 includes a conical upper portion with a small bead on a top end of the conical upper portion and includes an arcuate lower portion as shown in FIG. 8.

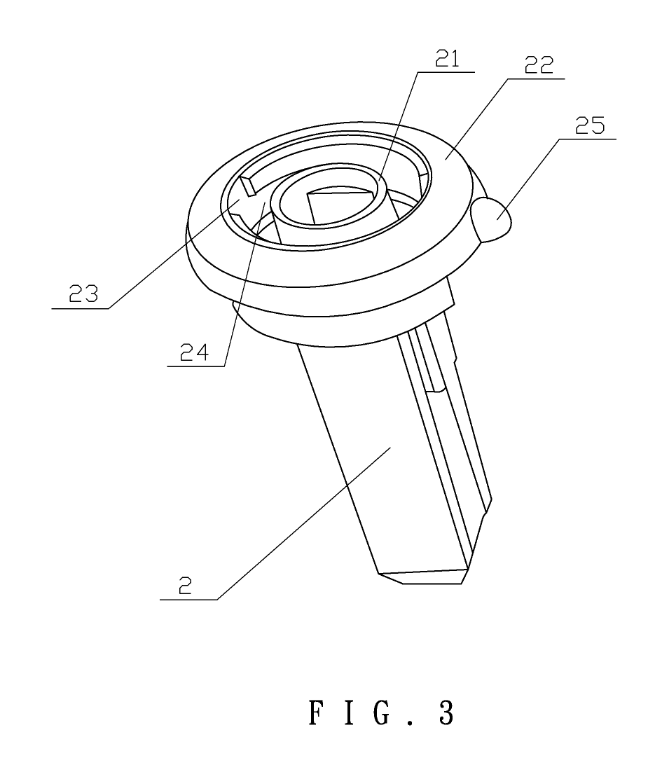

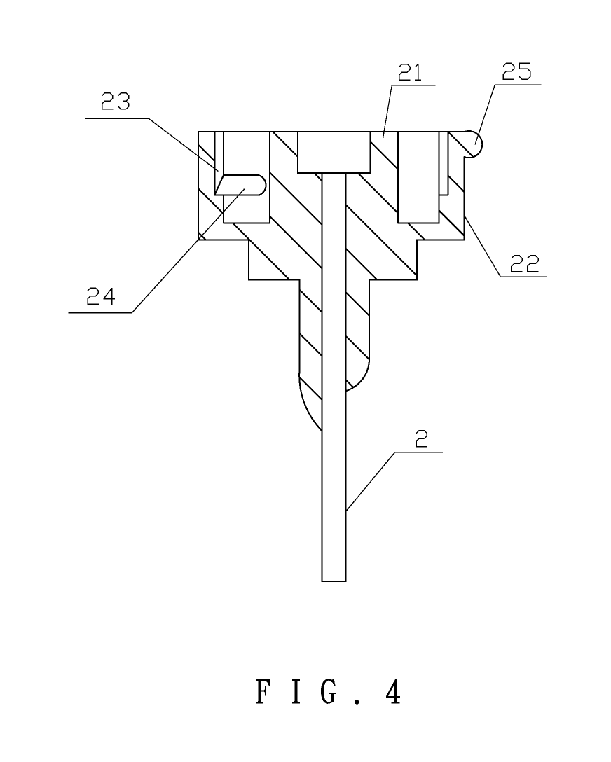

Referring to FIGS. 3 and 4, the soft core assembly 2 includes a hollow seat 21 to receive a LED element disposed on a top end thereof and a circular loop 22 concentric with the seat 21, wherein the loop 22 has an inner diameter to match with an outer diameter of the hollow column of the body 1 and al least one axial guiding slot 23 formed on an inner wall thereof, the at least one guiding slot 23 has a width to cooperate with the at least one boss 11, the loop 22 also has a stopping groove 24 perpendicular to and communicating with the at least one guiding slot 23, wherein a number of the at least one axial guiding slot 23 is equal to that of the at least one boss 11. The stopping groove 24 has a width becomes decreasingly, and the circular loop 22 further includes a positioning tab 25 secured on an outer surface thereof.

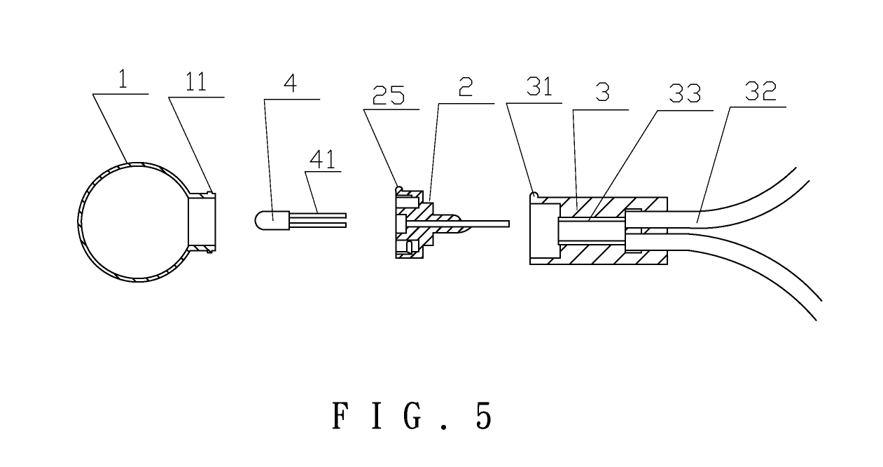

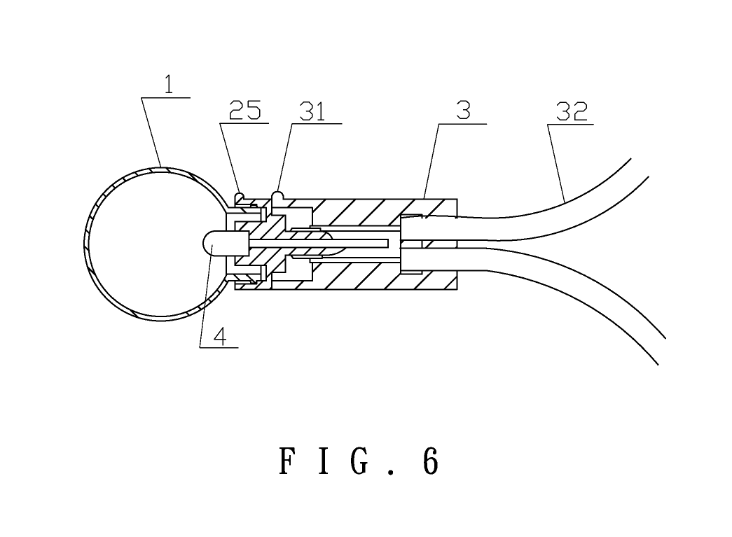

With reference to FIGS. 5 and 6, the LED element 4 with two legs 41 is inserted into the seat 21 of the soft core assembly 2 so that the two legs 41 are fixed on the soft core assembly 2, and a cable 32 with a terminal 33 is made of plastic material and integrally formed with a soft connecting member 3. The positioning tab 25 of the soft core assembly 2 is aligned with a fixing projection 31 of the soft connecting member 3 so that the soft core assembly 2 is inserted into the soft connecting member 3, and the two legs 41 extending downward from an upper portion of the LED element 4 are electrically connected with the terminal 33 of the cable 32 so that the at least one boss 11 of the body 1 is aligned with and pushed toward the leas one guiding slot 23 of the circular loop 22 of the soft core assembly 2, hence the body 1 is fixed in the soft core assembly 2, after the at least one boss 11 of the body 1 enters into a connection of the at least one guiding slot 23 and the stopping groove 24, the body 1 is rotated so that the least one boss 11 is rotated into the stopping groove 24, thus connecting the body 1 with the soft core assembly 2. Thereafter, the upper portion of the LED element 4 is inserted into the body 1. Because the width of the stopping groove 24 becomes decreasingly, the at least one boss 11 is retained in the stopping groove 24 securely. Thereby, the body 1, the soft core assembly 2, the soft connecting member 3, and the LED element 4 are connected together as illustrated in FIG. 6.

While we have shown and described various embodiments in accordance with the present invention, it is clear to those skilled in the art that further embodiments may be made without departing from the scope of the present invention.

What is claimed is:

1. A glass bulb cover comprising:
a hollow body (1) made of glass material and including a hollow column extending downward from the body (1), the hollow column includes at least one boss (11) arranged on an outer surface thereof to connect with a soft core assembly (2).

2. The glass bulb cover as claimed in claim 1, wherein the at least one boss (11) is formed in a trapezium shape.

3. The glass bulb cover as claimed in claim 1, wherein the at least one boss (11) is formed in a circular post shape.

4. The glass bulb cover as claimed in claim 1, wherein the at least one boss (11) is formed in a hemisphere shape.

5. The glass bulb cover as claimed in claim 1, wherein the at least one boss (11) is fixed and equiangularly spaced on the outer surface of the hollow column of the body (1).

6. The glass bulb cover as claimed in claim 2, wherein the at least one boss (11) is fixed and equiangularly spaced on the outer surface of the hollow column of the body (1).

7. The glass bulb cover as claimed in claim 3, wherein the at least one boss (11) is fixed and equiangularly spaced on the outer surface of the hollow column of the body (1).

8. The glass bulb cover as claimed in claim 4, wherein the at least one boss (11) is fixed and equiangularly spaced on the outer surface of the hollow column of the body (1).

9. The glass bulb cover as claimed in claim 1, wherein the soft core assembly (2) includes a hollow seat (21) to receive a LED element (4) disposed on a top end thereof, characterized in that the soft core assembly (2) includes a circular loop (22) concentric with the seat (21), the loop (22) has an inner diameter to match with an outer diameter of the hollow column of the body (1) and at least one axial guiding slot (23) formed on an inner wall thereof, the loop (22) also has a stopping groove (24) perpendicular to and communicating with the at least one guiding slot (23), and a number of the at least one axial guiding slot (23) is equal to that of the at least one boss (11).

10. The glass bulb cover as claimed in claim 9, wherein the stopping groove (24) has a width becomes decreasingly.

11. The glass bulb cover as claimed in claim 9, wherein the circular loop (22) further includes a positioning tab (25) secured on an outer surface thereof.

12. The glass bulb cover as claimed in claim 10, wherein the circular loop (22) further includes a positioning tab (25) secured on an outer surface thereof.
